(19) United States
(12) Patent Application Publication
(10) Pub. No.: US 2009/0307987 A1
(43) Pub. Date: Dec. 17, 2009

(54) ABRASIVE COMPACTS

(76) Inventors: Geoffrey John Davies, Randburg (ZA); Mosimanegape Stephen Masete, Johannesburg (ZA)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/375,320

(22) PCT Filed: Jul. 27, 2007
(86) PCT No.: PCT/IB2007/052990

§ 371 Date: Aug. 27, 2009

(30) Foreign Application Priority Data
Jul. 28, 2006 (ZA) 2006/06285

(51) Int. Cl. C09K 3/14

(52) U.S. Cl. 51/309

(57) ABSTRACT

Abrasive compacts, in particular ultrahard polycrystalline abrasive compacts, are made under high pressure/high temperature conditions and are characterized in that they include a coarser grained fraction of ultrahard particles distributed non-percolatively throughout a finer grained fraction of ultrahard particles, which may be regarded as a finer grained ultrahard particle matrix, in such a way that the individual coarser grains are largely isolated from one another. It therefore performs as a matrix of highly wear resistant finer grained material interspersed with larger grains, offering a structure that has advantageous wear and impact performance over the behaviours of the two components individually or otherwise combined.

### BACKGROUND OF THE INVENTION

This invention relates to abrasive compacts.

Abrasive compacts are used extensively in cutting, milling, grinding, drilling and other abrasive operations. Abrasive compacts consist of a mass of ultrahard particles, typically diamond or cubic boron nitride, bonded into a coherent, polycrystalline conglomerate. The abrasive particle content of abrasive compacts is high and there is generally an extensive amount of direct particle-to-particle bonding or contact. Abrasive compacts are generally sintered under elevated temperature and pressure conditions at which the abrasive particle, be it diamond or cubic boron nitride, is crystallographically or thermodynamically stable.

Some abrasive compacts may additionally have a second phase which contains a catalyst/solvent or binder material. In the case of polycrystalline diamond compacts, this second phase is typically a metal such as cobalt, nickel, iron or an alloy containing one or more such metals. In the case of PCBN compacts this binder material typically comprises various ceramic compounds.

Abrasive compacts tend to be brittle and in use they are frequently supported by being bonded to a cemented carbide substrate or support. Such supported abrasive compacts are known in the art as composite abrasive compacts. Composite abrasive compacts may be used as such in a working surface of an abrasive tool. The cutting surface or edge is typically defined by the surface of the ultrahard layer that is furtherest removed from the cemented carbide support.

Examples of composite abrasive compacts can be found described in U.S. Pat. Nos. 3,745,623; 3,767,371 and 3,743,489.

Composite abrasive compacts are generally produced by placing the components necessary to form an abrasive compact, in particulate form, on a cemented carbide substrate. The composition of these components is typically manipulated in order to achieve a desired end structure. The components may, in addition to ultrahard particles, comprise solvent/catalyst powder, sintering or binder aid material. This unbonded assembly is placed in a reaction capsule which is then placed in the reaction zone of a conventional high pressure/high temperature apparatus. The contents of the reaction capsule are then subjected to suitable conditions of elevated temperature and pressure.

It is desirable to improve the abrasion resistance of the ultrahard abrasive layer as this allows the user to cut, drill or machine a greater amount of the workpiece without wear of the cutting element. This is typically achieved by manipulating variables such as average ultrahard particle grain size, overall binder content, ultrahard particle density and the like.

For example, it is well known in the art to increase the abrasion resistance of an ultrahard composite by reducing the overall grain size of the component ultrahard particles. Typically, however, as these materials are made more wear resistant they become more brittle or prone to fracture. Abrasive compacts designed for improved wear performance will therefore tend to have poor impact strength or reduced resistance to spalling. This trade-off between the properties of impact resistance and wear resistance makes designing optimised abrasive compact structures, particularly for demanding applications, inherently self-limiting.

Additionally, because finer grained structures will typically contain more solvent/catalyst or metal binder, they tend to exhibit reduced thermal stability when compared to coarser grained structures. This reduction in optimal behaviour for finer grained structures can cause substantial problems in practical application where the increased wear resistance is nonetheless required for optimal performance.

Prior art methods to solve this problem have typically involved attempting to achieve a compromise by combining the properties of both finer and coarser ultrahard particle grades in various manners within the ultrahard abrasive layer.

One of the solutions well known in the art involves the use of macroscopic structures, such as layers or annuli, within the ultrahard layer, that contain separate regions of differing average grain size.

U.S. Pat. No. 4,311,490 describes an abrasive compact wherein the bonded abrasive particles comprise a coarse layer adjacent the carbide support and a fine layer placed above this as the cutting surface.

U.S. Pat. No. 4,861,350 describes a tool component comprising an abrasive compact bonded to a cemented carbide support in which the abrasive compact has two zones which are joined by an interlocking, common boundary. The one zone provides the cutting edge or point for the tool component, while the other zone is bonded to the cemented carbide support. In one embodiment of the tool component, the zone which provides the cutting edge or point has ultra-hard abrasive particles which are finer than the ultra-hard abrasive particles in the other zone.

U.S. Pat. No. 5,645,617 also teaches the use of layers in the composite structure, each with different average particle sizes. In this case, the structure is arranged such that the finer grained layers are adjacent the carbide support, whilst the coarser grained layers comprise the cutting surface. It is claimed that this arrangement allows a better sintering behaviour that results in a compact with improved performance capability.

U.S. Pat. No. 6,187,068 teaches the separation of ultrahard particles into laterally spaced regions, rather than layers, of discrete particle size areas. The areas formed of the finer size particles are claimed to provide a higher abrasion resistance and hence a lower wear rate. In conjunction with the regions of coarser sized particles, a beneficial pattern of wear is claimed.

U.S. Pat. No. 6,193,001 teaches the use of a macroscopic non-uniform interface between either the cutting and substrate layers, or the cutting and various intermediate transition layers. These layers will typically be of differing material type or can be of differing physical property, such as grain size. The layers or regions are produced by embossing various interconnecting sheets or regions that are then compacted in the green state prior to sintering.

The problem with these solutions is that the areas of differing material type are still significantly large in size i.e. several times larger than the scale of individual grains. Hence each region is still limited by the overall wear and impact resistance of the comprising material. Rather than achieving an optimal blend of the properties of fine- and coarse-grained structures, the compact therefore tends to be afflicted with the weaknesses of both. Additionally, the differing properties of the discrete particle size areas can produce substantial stresses along the inter-region boundaries, which can themselves lead to catastrophic fracture of the polycrystalline material.

A further refinement of this type of solution involves the use of combining discrete material regions on a far finer scale to that typical of the approaches above. This usually involves the ordering of microscopic structural units of differing material phases that are woven or packed together. U.S. Pat. Nos. 6,696,137; 6,607,835; 6,451,442 and 6,841,260 describe several pre-synthesis routes to this type of embodiment. Typically these involve extruding and/or weaving together composite materials in the green state and then packing these into a three-dimensional structure. All of these routes are extremely technology-intensive and hence very costly. Additionally because of pre-synthesis handling limitations they rely on fairly complex chemical compositions which tend to have a detrimental effect on material performance.

U.S. Pat. No. 7,070,635 discloses a polycrystalline diamond element that comprises aggregates of fine diamond dispersed in a matrix of coarser grained diamond. It is claimed that this structure achieves improved behaviour by biasing impact failures towards smaller chipping events rather than more substantial spalling events. The problem with this structure is that, although impact failure may be better controlled, the wear resistance of the compact is still dominated by the coarser grained matrix and hence tends to be insufficient for demanding applications.

Another approach to solving the problem of achieving an optimal marriage of properties between coarser- and finer-grained structures lies in the use of intimate powder mixtures of ultrahard grains of differing sizes. These are typically mixed as homogenously as possible prior to sintering the final compact. Both bimodal distributions (comprising two particle size fractions) and multimodal distributions (comprising three or more fractions) of ultrahard particles are known in the art.

U.S. Pat. No. 4,604,106 describes a composite polycrystalline diamond compact that comprises at least one layer of interspersed diamond crystals and pre-cemented carbide pieces which have been sintered together at ultra high pressures and temperatures. In one embodiment, a mixture of diamond particles is used, 65% of the particles being of the size 4 to 8 μm and 35% being of the size 0.5 to 1 μm. A specific problem with this solution is that the cobalt cemented carbide reduces the abrasion resistance of that portion of the ultrahard layer.

U.S. Pat. No. 4,636,253 teaches the use of a bimodal distribution to achieve an improved abrasive cutting element. Coarse diamond (larger than 3 μm in particle size) and fine diamond (smaller than 1 μm in particle size) is combined such that the coarse fraction comprises 60 to 90% of the ultrahard particle mass; and the fine fraction comprises the remainder. The coarse fraction may additionally have a trimodal distribution.

U.S. Pat. No. 5,011,514 describes a thermally stable diamond compact comprising a plurality of individually metal-coated diamond particles wherein the metal coatings between adjacent particles are bonded to each other forming a cemented matrix. Examples of the metal coating are carbide formers such as tungsten, tantalum and molybdenum. The individually metal-coated diamond particles are bonded under diamond synthesis temperature and pressure conditions. The patent further discloses mixing the metal-coated diamond particles with uncoated smaller sized diamond particles which lie in the interstices between the coated particles. The smaller particles are said to decrease the porosity and increase the diamond content of the compact. Examples of bimodal compacts (two different particle sizes), and trimodal compacts, (three different particles sizes), are described.

U.S. Pat. Nos. 5,468,268 and 5,505,748 describe the manufacture of ultrahard compacts from a mass comprising a mixture of ultrahard particle sizes. The use of this approach has the effect of widening or broadening of the size distribution of the particles allowing for closer packing and minimizing of binder pool formation, where a binder is present.

U.S. Pat. No. 5,855,996 describes a polycrystalline diamond compact which incorporates different sized diamond. Specifically, it describes mixing submicron sized diamond particles together with larger sized diamond particles in order to create a more densely packed compact.

U.S. Pat. Application No. 2004/0062928 further describes a method of manufacturing a polycrystalline diamond compact where the diamond particle mix comprises about 60 to 90% of a coarse fraction having an average particle size ranging from about 15 to 70 μm and a fine fraction having an average particle size of less than about one half of the average particle size of the coarse fraction. It is claimed that this blend results in an improved material behaviour.

The problem with this general approach is that whilst it is possible to improve the wear and impact resistances when compared with either the coarse or fine-grained fraction alone, these properties still tend to be compromised i.e. the blend has a reduced wear resistance when compared to the finer grained material alone and a reduced impact resistance when compared to the coarser grained fraction. Hence the result of using an intimate mixture of particle sizes is simply to achieve the property of the average intermediate particle size.

The development of an abrasive compact that can achieve improved properties of impact and fatigue resistance consistent with coarser grained materials, whilst still retaining the superior wear resistance of finer grained materials, is therefore highly desirable.

### SUMMARY OF THE INVENTION

According to a first aspect of the invention, there is provided an abrasive compact comprising a first fraction of ultrahard abrasive particles having a coarser average particle grain size and a second fraction of ultrahard abrasive particles having a finer average particle grain size, the first fraction of coarser grained ultrahard abrasive particles being distributed non-percolatively throughout the second fraction of finer grained ultrahard abrasive particles.

The invention further provides a method of manufacturing an abrasive compact, including the steps of subjecting a mass of ultrahard abrasive particles to conditions of elevated temperature and pressure suitable for producing an abrasive compact, the method being characterized by the mass of ultrahard particles having a first fraction of ultrahard abrasive particles having a coarser average particle size and a second fraction of ultrahard abrasive particles having a finer average particle size, the first fraction of coarser ultrahard abrasive particles being distributed non-percolatively throughout the second fraction of finer grained ultrahard abrasive particles.

According to a further aspect of the invention there is provided an abrasive compact comprising ultrahard abrasive particles having an average particle grain size of less than about 10 μm, a first fraction of the ultrahard abrasive particles having a coarser average particle grain size and a second fraction of the ultrahard abrasive particles having a finer average particle grain size, the first fraction of coarser grained ultrahard abrasive particles being distributed non-percolatively throughout the second fraction of finer grained ultrahard abrasive particles.

In this aspect of the invention, the coarser and finer ultrahard abrasive particles are typically provided in a 50/50 mixture, the average particle grain size of the coarser fraction being about 8.5 to 10 μm, preferably about 9.5 μm and that of the finer fraction being about 1.0 to 2.5μm, preferably about 1.5 μm.

The invention extends to the use of the abrasive compacts of the invention as abrasive cutting elements, for example for cutting or abrading of a substrate or in drilling applications.

### DESCRIPTION OF PREFERRED EMBODIMENTS

The present invention is directed to abrasive compacts, in particular ultrahard polycrystalline abrasive compacts, made under high pressure/high temperature conditions. The abrasive compacts are characterized in that they include a coarser grained fraction of ultrahard particles distributed non-percolatively throughout a finer grained fraction of ultrahard particles, which may be regarded as a finer grained ultrahard particle matrix, in such a way that the individual coarser grains are largely isolated from one another.

The composite material of the abrasive compacts therefore performs as a matrix of highly wear resistant finer grained material interspersed with larger grains, offering a structure that has advantageous wear and impact performance over the behaviours of the two components individually or otherwise combined.

The ultrahard abrasive particles may be diamond or cubic boron nitride, but are preferably diamond particles.

The ultrahard abrasive particle mass will be subjected to known temperature and pressure conditions necessary to produce an abrasive compact. These conditions are typically those required to synthesize the abrasive particles themselves. Generally, the pressures used will be in the range 40 to 70 kilobars and the temperature used will be in the range 1300° C. to 1600° C.

The abrasive compact will generally and preferably have a binder present. The binder will preferably be a catalyst/solvent for the ultrahard abrasive particle used. Catalyst/solvents for diamond and cubic boron nitride are well known in the art. In the case of diamond, the binder is preferably cobalt, nickel, iron or an alloy containing one or more of these metals.

When a binder is used, particularly in the case of diamond compacts, it may be caused to infiltrate the mass of abrasive particles during compact manufacture. A shim or layer of the binder may be used for this purpose. Alternatively, and preferably, the binder is in particulate form and is mixed with the mass of abrasive particles.

The abrasive compact, particularly for diamond compacts, will generally be bonded to a cemented carbide support or substrate forming a composite abrasive compact. To produce such a composite abrasive compact, the mass of abrasive particles will be placed on a surface of a cemented carbide body before it is subjected to the elevated temperature and pressure conditions necessary for compact manufacture. The cemented carbide support or substrate may be any known in the art such as cemented tungsten carbide, cemented tantalum carbide, cemented titanium carbide, cemented molybdenum carbide or mixtures thereof. The binder metal for such carbides may be any known in the art such as nickel, cobalt, iron or an alloy containing one or more of these metals. Typically, this binder will be present in an amount of 10 to 20 mass %, but this may be as low as 6 mass %. Some of the binder metal will generally infiltrate the abrasive compact during compact formation.

A method for generating compacts of the invention is typically characterized by the abrasive particle mixture that is used. The ultrahard particles used in the present process can be natural or synthetic. The mixture is bimodal, i.e. comprises a mixture of a coarser fraction and a finer fraction that differ from one another discernibly in their average particle size. By “average particle size” it is meant that the individual particles have a range of sizes with the mean particle size representing the “average”. Hence the major amount of the particles will be close to the average size although there will be a limited number of particles above and below the specified size. The peak in the distribution of the particles will therefore be at the specified size. The size distribution for each ultrahard particle size fraction is typically itself monomodal, but may in certain circumstances be multimodal. In the sintered compact, the term “average particle grain size” is to be interpreted in a similar manner.

The mixture of ultrahard particles is chosen in such a way as to generate a final compact structure where the coarser grained particles are isolated from one another. Typically this isolation can be expressed by saying that the arrangement of the coarser grains is non-percolative in the composite structure. Accordingly, there is no continuous path from one side or surface of the composite to another through interconnected or immediately adjacent coarser grains

Percolation theory can be used to describe the behaviour of a multiphase composite (i.e. a composite comprising at least two discrete material phases). Where these materials have differences in their responses or properties when exposed to an energy or matter flux, percolation theory can be used to explain the overall behaviour of the complete multiphase composite when exposed to the energy or matter flux.

For example, considering a system where particles of high electrical conductivity are embedded in a matrix phase of low electrical conductivity, if there is no continuous path formed by the conductive component within the composite, then a relatively low overall conductivity of the body is expected. However, above a certain volume fraction of conductive particles, there would be a significant probability of forming a continuous conductive path spanning the length of the body. At this point the body would begin to exhibit a high electrical conductivity. At this critical volume fraction (which is dependent on several factors such as the shape and distributions of the conductive particles) the material is said be percolative in nature with respect to the conductive phase. Below this volume fraction (known as the percolation threshold), the body is said to be non-percolative. Hence a body which is percolative with respect to any particulate phase will readily contain uninterrupted connecting chains of that particle type spanning the length of the body. Below the percolation threshold, however, the probability of forming a continuous percolative path is highly improbable, as the volume fraction is insufficiently high.

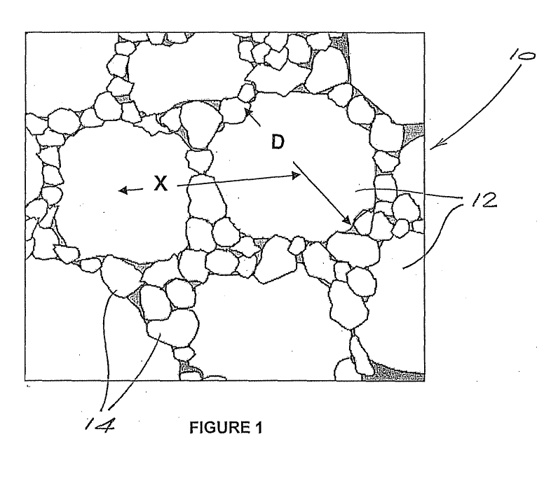

In the present invention, this percolative threshold has been found to be the limiting factor for the optimal structure of the bimodal, ultrahard composite. Hence the ultrahard composite structure of the invention is characterised in that the structure is non-percolative with respect to the coarser grained ultrahard particle fraction. This is further illustrated in FIG. 1, which is a schematic representation of the optimal structure 10 of an abrasive compact of the invention comprising coarser grained particles 12 distributed in a matrix of finer grained particles 14. D is the average particle diameter of the coarser grain particles 12 and X is the average distance between the centres of each of the coarser grain particles 12. In a non-percolative structure, the average value of X will exceed the average value of D, indicating that there is, on average, minimal contact between coarser grain particles 12. It should be noted that even for low fractions of coarser particles, there may arise a number of instances where the coarser particles would cluster together to form a continuous chain spanning several particle diameters, although the probability of there being a chain spanning the length of an arbitrarily shaped body would still be close to zero.

It is known in the art that larger grains occurring in a dominantly finer grained matrix composite can act as flaws. These will tend to compromise the structure and hence the properties of the finer grained material by acting as early points of failure. It would therefore be expected that a structure comprising coarse grains dispersed in a discernibly finer-grained matrix will not possess structural advantages over the finer-grained material alone. It has surprisingly been found, however, that the presence of coarser grains in a sufficiently isolated, preferably a homogenous or well distributed, arrangement can result in a material of superior behaviour. It is postulated that these hitherto unknown advantages result from the implied separation between coarse grains in the final structure, which ensures that the material behaves as a true composite structure with neither component weakening the final behaviour. In addition, it may be that positive alterations in the sintering behaviour of the finer grained ultrahard composite portion are brought about by the presence of the coarser grains.

The percolative threshold for ultrahard compacts can be determined based on various factors relating to the character of the component particles, for example size or shape. The most preferred overall particle sizes of this invention are less than 20 μm. At these sizes, it has been found that the percolation threshold for the coarser fraction is typically less than about 60% coarse particles, with the remainder comprising the finer fraction. The more preferred volume fraction of the coarser fraction is less than about 55% and the most preferred at around 50%. Where the fraction of coarser particles becomes too small, then the improvements in behaviour are not typically observed. Hence the coarser grained component should exceed at least about 20%.

It has also been found that there exists a preferred ratio between the size of the coarser and finer grained particles. The most optimal arrangement appears to occur where the ratio of the size of the coarser to the size of the finer particles is between 2:1 and 10:1, more preferably 3:1 and 8:1; and most preferably between 5:1 and 7:1.

A further aspect of the invention is the use of this structural type at overall finer average grain sizes (i.e. the average of both fine and coarse fractions) typically less than 10 μm.

In one preferred embodiment thereof, a 50/50 mixture of diamond particles with a finer fraction of average particle grain size of about 1 to 2.5 μm, preferably about 1.5 μm, and a coarser fraction of average particle grain size of about 8.5 to 10 μm, preferably about 9.5 μm is provided. An additional 1 mass % of cobalt catalyst/solvent powder is admixed into the diamond powder mixtures as this has been found to aid in achieving optimal sintering processes for this system. This composite structure has superior combined wear and impact resistance when compared with the composites made from single fractions of polycrystalline diamond alone; and when compared to composites with the same overall average grain size.

In a further preferred embodiment thereof, a 50/50 mixture of diamond particles with a finer fraction of average particle grain size of about 0.5 to 1.0 μm, preferably about 0.7 μm; and a coarser fraction of average particle grain size of about 4 to 6 μm, preferably about 4.5 μm, is provided. An additional 1 mass % of cobalt catalyst/solvent powder is admixed into the diamond powder mixtures as this has been found to aid in achieving optimal sintering processes for this system. This composite structure has both superior wear resistance and impact resistance when compared with composites made from the single fractions of polycrystalline diamond alone and when compared to composites with the same overall average grain size.

The invention is now illustrated by the following non-limiting examples:

### EXAMPLE 1

A suitable bimodal diamond powder mixture was prepared. A quantity of sub-micron cobalt powder sufficient to obtain 1 mass % in the final diamond mixture was initially de-agglomerated in a methanol slurry in a ball mill with WC milling media for 1 hour. The fine fraction of diamond powder with an average grain size of 1.5 μm was then added to the slurry in an amount to obtain 49.5 mass % in the final mixture. Additional milling media was introduced and further methanol was added to obtain a suitable slurry; and this was milled for a further hour. The coarse fraction of diamond, with an average grain size of ca. 9.5 μm, was then added in an amount to obtain 49.5 mass % in the final mixture. The slurry was again supplemented with further methanol and milling media, and then milled for a further 2 hours. The slurry was removed from the ball mill and dried to obtain the diamond powder mixture.

The diamond powder mixture was then placed into a suitable HpHT vessel, adjacent to a WC substrate and sintered under conventional HpHT conditions to achieve a final abrasive compact.

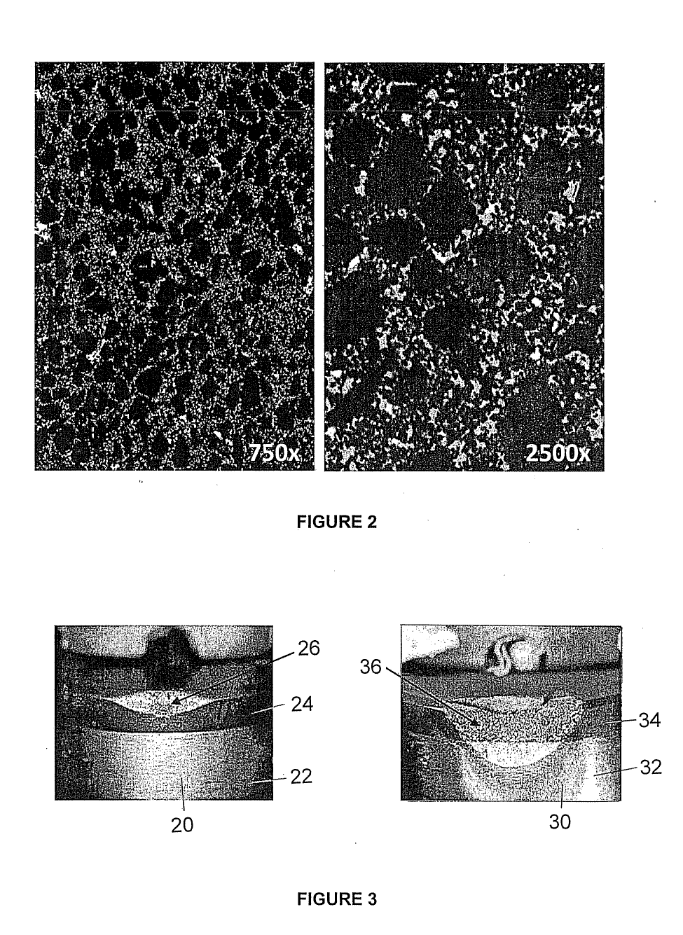

FIG. 2 shows two scanning electron micrographs at different magnifications of this sample that illustrate the percolative distribution of the coarse grains within the finer-grained matrix. The average effect of isolating the coarse particles from one another is evident, particularly at the higher magnification of 2500×.

This compact was tested in a standard applications-based test where it showed significant performance improvement over that of a prior art compact with a similar average diamond grain size, which had a monomodal distribution. FIG. 3 shows images of the relative performance of the compact 20 of the invention, comprising the WC substrate 22 and polycrystalline diamond layer 24 having a wear scar 26, against the prior art compact 30 (WC substrate 32; polycrystalline diamond layer 34; wear scar 36) at the same stage in the test, where the increased rate of wear and evidence of chipping of the prior art compact 30 is extremely pronounced

### EXAMPLE 2

A bimodal diamond mixture was prepared similar to that in example 1, save that the diamond grain sizes employed were 0.7 μm for the fine fraction and 4.5 μm for the coarse fraction, respectively. A diamond compact was prepared in the same manner and tested under similar circumstances. It too showed a significant improvement in performance in an application-based test when compared to a monomodal prior art cutter of similar grain size.

1. An abrasive compact comprising a first fraction of ultrahard abrasive particles having a coarser average particle grain size and a second fraction of ultrahard abrasive particles having a finer average particle grain size, the first fraction of coarser grained ultrahard abrasive particles being distributed non-percolatively throughout the second fraction of finer grained ultrahard abrasive particles.

2. The abrasive compact according to claim 1, wherein the abrasive compact has an overall average particle grain size of less than 20 μm.

3. The abrasive compact according to claim 1, wherein the first fraction of ultrahard abrasive particles comprises less than about 60% of the abrasive compact.

4. The abrasive compact according to claim 3, wherein the first fraction of ultrahard abrasive particles comprises less than about 55% of the ultrahard abrasive phase of the compact.

5. The abrasive compact according to claim 1, wherein the first fraction of ultrahard abrasive particles comprises greater than about 20% of the ultrahard abrasive phase of the compact.

6. The abrasive compact according to claim 1, wherein the first fraction of ultrahard abrasive particles comprises about 50% of the ultrahard abrasive phase of the compact.

7. The abrasive compact according to claim 1, wherein the average distance, X, between the centres of the respective ultrahard abrasive particles of the first fraction is greater than the average particle diameter D of the respective ultrahard abrasive particles of the first fraction.

8. The abrasive compact according to claim 1, wherein the ratio of the average size of the ultrahard abrasive particles of the first fraction to that of the second fraction is greater than 2:1.

9. The abrasive compact according to claim 8, wherein the ratio of the average size of the ultrahard abrasive particles of the first fraction to that of the second fraction is greater than 3:1.

10. The abrasive compact according to claim 1, wherein the ratio of the average size of the ultrahard abrasive particles of the first fraction to that of the second fraction is less than 10:1.

11. The abrasive compact according to claim 10, wherein the ratio of the average size of the ultrahard abrasive particles of the first fraction to that of the second fraction is less than 6:1.

12. The abrasive compact according to claim 11, wherein the ratio of the average size of the ultrahard abrasive particles of the first fraction to that of the second fraction is less than 5:1.

13. An abrasive compact comprising ultrahard abrasive particles having an average particle grain size of less than about 10 microns, a first fraction of the ultrahard abrasive particles having a coarser average particle grain size and a second fraction of the ultrahard abrasive particles having a finer average particle grain size, the first fraction of coarser grained ultrahard abrasive particles being distributed non-percolatively throughout the second fraction of finer grained ultrahard abrasive particles.

14. The abrasive compact according to claim 13, wherein the coarser and finer ultrahard abrasive particles are provided in a generally 50/50 mixture, the average particle grain size of the coarser fraction being about 8.5 to 10 μm and that of the finer fraction being about 1.0 to 2.5 μm.

15. The abrasive compact according to claim 14, wherein the average particle grain size of the coarser fraction is about 9.5 μm.

16. The abrasive compact according to claim 14, wherein the average particle grain size of the finer fraction is about 1.5 μm.

17. The abrasive compact according to claim 13, wherein the coarser and finer ultrahard abrasive particles are provided in a generally 50/50 mixture, the average particle grain size of the coarser fraction being about 4 to 6 μm and that of the finer fraction being about 0.5 to 1 μm.

18. The abrasive compact according to claim 14, wherein the average particle grain size of the coarser fraction is about 4.5 μm.

19. The abrasive compact according to claim 14, wherein the average particle grain size of the finer fraction is about 0.7 μm.
